(19) United States
(12) Patent Application Publication
(10) Pub. No.: US 2004/0176008 A1
(43) Pub. Date: Sep. 9, 2004

(54) Mattress cover and a method of manufacturing the same, as well as a mattress

(76) Inventor: Francis Norbert Marie Lampe, Ruddervoorde Oostkamp (BE)

Correspondence Address: CROWELL & MORING LLP, INTELLECTUAL PROPERTY GROUP, P.O. BOX 14300, WASHINGTON, DC, 20044-4300, US

(21) Appl. No.: 10/474,729

(22) PCT Filed: Mar. 18, 2003
(86) PCT No.: PCT/IB03/00978

(30) Foreign Application Priority Data
Mar. 19, 2002 (NL) 1020206

(51) Int. Cl. B32B 5/26; D04H 3/16; B32B 31/20

(52) U.S. Cl. 442/268; 442/277; 442/415; 442/401

(57) ABSTRACT

The present invention relates to a mattress cover formed of a composite material consisting of a nonwoven material and a woven layer, in which the nonwoven material comprises a single nonwoven layer, and in which said nonwoven layer and said woven layer are permanently bonded together whilst retaining the flexible character of the woven layer.

The present invention relates to a mattress cover, to a method of manufacturing the same, to the use of such a mattress cover, and in particular to a mattress provided with a mattress cover.

U.S. Pat. No. 5,187,005 relates to a so-called fabric composite, comprising a layer of a fibrous, nonwoven web and a layer of woven thermoplastic yarns. The layer of woven thermoplastic yarns is in the form of a woven fabric, such as a softside luggage fabric, a wall covering fabric or a leno weave fabric. The nonwoven layer and the woven layer can be bonded together by means of a polymer-like material in the form of a hot melt, and extrusion coating composition or a water-based bonding agent. Said layers may also be bonded together directly, i.e. without using a polymer-like material, by means of a thermal bonding process, for example via a calendering process. Polypropylene, polyester, polyamide, among other substances, and the like are mentioned as possible thermoplastic resins for the nonwoven layer. The woven layer only comprises synthetic materials. The special application of such a composite material as a mattress cover, let alone the specific requirements made of such an application, is not known from said document.

U.S. Pat. No. 5,192,601 relates to a composite material consisting of a first woven layer and a nonwoven second layer, in which a number of thermoplastic fibres in the first woven layer have been subjected to a mechanical treatment, the so-called needle punching, in such a manner that such fibres extend into and through the nonwoven second layer. When such a composite material is heated to a temperature above the plasticizing temperature of the thermoplastic fibre, a close contact between the two individual layers will be obtained, in which the woven layer is preferably formed of polypropylene fibres and polyester fibres and in which the nonwoven layer is formed of polypropylene fibres. One drawback of such a thermal treatment is that the yarn will shrink and harden, which is undesirable. In addition, said needle punching constitutes an additional mechanical step, which additional step is undesirable, because it increases the costs and may lead to disturbances in the production process.

From U.S. Pat. No. 5,311,624 there is known a mattress cover consisting of a two-layer laminated construction comprising a liquid-resistant layer, which is laminated or otherwise bonded to a backing to layer. The liquid-resistant layer is made of vinyl, and said layer also comprises an antimicrobial agent. The backing layer is a non-woven polypropylene fabric. In the lamination process, the backing layer, which consists of a structured nonwoven web, is bonded to the vinyl layer under pressure, using a bonding agent and a heated roller. One drawback of such a two-layer construction is that the use of a vinyl layer will completely change the character of the mattress cover, especially as regards aspects such as touch or grip. Another drawback is that the vinyl layer is insufficiently pervious to moisture, so that it can only be used as a mattress cover in special cases.

From International patent application WO 99/56588 there is known a covering material for a bed or a pillow, comprising a multi-layer nonwoven fabric, which is in direct contact with the interior or with the mattress and which encases the same, which fabric is furthermore enveloped by an outer fabric, which is integrally attached to the multi-layer nonwoven fabric. The multi-layer nonwoven fabric is of the three-layer type, viz. a spunbonded-melt-blown-spunbond laminate. No information whatever relating to the combination of a single nonwoven layer and a woven layer, let alone the manner in which such layers are permanently bonded together without the flexible character of the woven layer being affected.

Furthermore there is known a method of applying a coating to the rear side of a woven material, which method employs acrylic resins, among other substances, which are applied to the woven material in the form of a foam, using a squeegee device. The air bubbles in the foam enable the mattress cover to “breathe”. Such a finishing method requires a major investment in equipment, and in addition to that it burdens the environment by emitting solvents that are incorporated in the foam solution. Moreover, the glossy character of the woven material will be lost to a certain extent as a result of the foam penetrating the woven structure, which is considered to be disadvantageous in practice. In addition to that, the desired flexible character of a mattress cover produced by means of such a method is slightly diminished due to the presence of the foamy material.

It is an object of the present invention to provide a composite material, in particular a mattress cover, in which the advantageous properties of a woven carrier layer, in particular the resitance against slippage, the seam strength and the touch or grip thereof, are retained or improved.

Another object of the present invention is to provide a method of manufacturing a composite material, in particular a mattress cover, which method minimises the use of equipment and/or of solvents that burden the environment.

Another object of the present invention is to provide a composite material composed of inexpensive materials, which composite material is to be used in particular as a mattress cover, for which use it must meet the requirements that are currently made of mattress covers, in particular as regards the resistance against slippage, the seam strength and the flexibility.

Yet another object of the present invention is to provide a mattress, which mattress is provided with a mattress cover which is well confectionable, having a high seam strength and a high gloss.

Yet another object of the present invention is to provide a composite material which practically does not fray and which does not exhibit any “tacking”, i.e. a fabric which is slightly sticky, plastic-like to the touch.

Another aspect of the present invention relates to the provision of a mattress cover formed of a stabler fabric, which is less liable to fraying and which thus enables a quicker and more efficient mass-production.

Another aspect of the present invention relates to the provision of a mattress cover that meets specific requirements as regards seam strength, resistance against slippage and stability, which requirements cannot be met with the known coating system, which employs a squeegee device, in particular as regards the number of shots/cm.

According to the present invention, the mattress cover is characterized in that the nonwoven material comprises a single nonwoven layer, in which said nonwoven layer and said woven layer are durably or permanently bonded together whilst retaining the flexible character of the woven layer.

It is in particular preferable to carry out said permanent bonding together by means of a scatter coating process, a hot melt process or by the application of a bonding agent between the two layers, in which it is in particular desirable to use the scatter coating process.

The use of the scatter coating process eliminates the emission of environmentally harmful solvents as well as the emission of environmentally harmful gases. In addition, the relatively inexpensive nonwoven materials provide a mattress cover in which the original gloss of the woven material is more or less retained, in which the strength of the material is enhanced and in which an improved grip or touch is provided. Furthermore, advantageous results are obtained in the field of waste water control, noise levels and energy costs. Because of the use of the scatter coating process, no bonding agent will permeate to the yarn or to the front side of the fabric. In addition, fraying of small weft or warp yarns is not possible in the present structure of layers of the mattress cover. Furthermore, gas fading cannot occur due to the absence of acrylates. Moreover, the use of the scatter coating process makes it possible to change or modify the properties of the mattress cover in a simple manner, for example by adding specific additives to the scatter coating material, such as anti-dust mite agents, fire retardants, antifungal agents, antibacterial agents, anti-mosquito agents, antiallergenic agents, water and/or oil repellants, antistatic agents, health-promoting agents, magnetic powders, thermal regulators, shape-memorising agents, self-cleaning agents, melamine-decomposing agents and the like. In addition to that it is also possible to incorporate specific rock types that are assumed to have a healing effect, as well as Aloe Vera and odour absorbing or releasing substances. It should be understood that such additives can be incorporated both via an additional powder or liquid and via a specific additional processing step, for example a spraying step, corona treatment, plasma treatment or wet application. Furthermore, such property-modifying additives may already have been added to the individual layers, in particular via the nonwoven layer.

The nonwoven material, also called web, is selected from the group consisting of polypropylene, polyester, polyamide, acetate and viscose, or a mixture of one or more thereof, in particular polypropylene is used.

In specific embodiments, the single nonwoven layer that is used in the present invention may be composed of two separate sublayers of a nonwoven material, in which the sublayers may be mutually different, for example of the types “dry laid”, “wet laid” and “extruded”, as already discussed before. Such a combination is especially advantageous for modifying specific properties of the composite material, and this case of the present mattress cover, for example the air-permeability thereof.

As is generally known, web materials are subdivided into three main groups, viz. “wet laid”, “dry laid” and “extruded”, which latter group can be further subdivided into mechanical carding and combing on the one hand and air penetration on the other hand. The webs that are obtained through air penetration must undergo one or more additional treatments in order to obtain the required tensile strength and dimensional stability. A treatment which is in particular preferred is thermal bonding, in which the fibres are bonded together and the desired properties are imparted to the web by using heat. Another preferred treatment is an extrusion process or a spunbonding process, in which filaments of fibres, in particular polypropylene, are sprayed from nozzles, forming a web after curing and/or calendering, in which said calendering in particular functions to fix the fibres additionally at specific locations. The use of polypropylene is in particular desirable because of the lower specific weight thereof, so that a larger volume per unit area is possible with the same weight, which is especially important for the special use of the present composite material. In addition, polypropylene is available on a large scale and at low cost.

The nonwoven material preferably has a weight of maximally 50 g/m², in particular maximally 20 g/m², in particular in the range of 12-20 g/m². If a weight outside the above range is used, the obtained mattress cover will have a grip that will be characterized as too stiff. In addition, such a mattress cover will be unattractive because of its price. The properties of the final composite material, such as the transparency and the weight per unit area, can be varied via the selection of a special nonwoven material.

In the present mattress cover, the woven material is selected from yarns made from polypropylene, polyethylene, polyacryl, chlorine fibre, aramid, kevlar, elastane, Lyocell (brand), Tencel (brand), jute, hemp, ramie, sisal, silk, carbon fibre, glass fibre, banana fibres, bamboo, viscose, polyester, polyamide, acetate, cotton, flax, maize and wool, or a mixture of two or more thereof, for example polyester/cotton yarn, cotton/flax yarn, polyamide/elastane yarn, cotton/viscose/polyester yarn, polyamide/wool yarn, which enumeration must not be construed as being limitative but merely as being illustrative. Such yarns may be used as weft yarns and/or as warp yarns.

It is in particular preferable to use a combination of polypropylene and polyester as the woven material. Such a combination, in which polypropylene is preferably used as the weft yarn and polyester is used as the warp yarn, makes the mattress cover flexible and voluminous to the touch, whilst in addition the gloss is retained.

It is in particular preferable to use a warp density of 10-90 yarns/cm for the present mattress cover fabrics. In addition to that it is desirable to use a weft density of 4-50 shots/cm for the present mattress cover fabrics. This enables a fabric weight of 40-1000 g/m².

In a special embodiment, the present mattress cover is woven in accordance with the Jacquard principle, but in specific embodiments it is desirable to use linen weave, twill weave, satin weave or a combination thereof. Although the term weaving is consistently used in the present description, it should be understood that it may be preferable in particular embodiments to knit the fabric, in which, depending on the division (the number of needles per inch) that is used, knits falling within the above-mentioned range can be obtained.

The present invention furthermore relates to a method of manufacturing a mattress cover consisting of a nonwoven material and a woven material, which method is according to the present invention characterized in that it comprises the following steps:

a) providing a nonwoven material,

b) providing a woven material,

c) applying a bonding agent to the woven material of step b) or to the nonwoven material of step a),

d) combining the nonwoven material from step a) and the woven material from step b) in such a manner that the bonding agent that has been applied in step c) is present between the two materials, and

e) treating the assembly thus obtained in such a manner that the mattress cover is obtained, in which the nonwoven layer from step a) and the woven layer from step b) are permanently bonded together whilst retaining the flexible character of the woven layer.

Such a method thus provides a permanent bond between the nonwoven layer and the woven layer, in which the original advantageous properties of the woven layer, in particular the gloss, the flexibility and the touch, are retained or improved, which properties are also retained with normal use and after washing.

Suitable treatments as used in step e) include: calendering, high-frequency heating, ultrasonic treatment, bonding through UV radiation and thermal bonding, for example by exposure to infrared light, with the possible use of a press-on force, with calendering being preferred for the sake of convenience, reproduceability, accuracy and speed. The calendering treatment, especially when a fixing calender is used, provides a more voluminous and thus finer fabric.

With a view to obtaining a durable bond between the nonwoven layer and the woven layer on the one hand and maintaining the flexible character of the woven layer on the other hand, in particular for the present use as a mattress cover, it is desirable to use a scatter coating material as the bonding agent used in step c), preferably in an amount of 8-20 g/m², in particular 5-20 g/m². An amount of scatter coating material less than the aforesaid lower limit does not provide a sufficient bonding power, whilst an amount in excess of the aforesaid upper limit makes the final product too expensive and too stiff. However, it may be advantageous in a specific embodiment to apply the bonding agent according to step c) in the form of a paste or dots, a bonding agent foil, viz. a film, a web or a net. Suitable bonding agents include: UV curing resins, light-sensitive resins and pressure-sensitive bonding agents, possibly combined with irradiation with infrared light or UV light. For example, if the nonwoven layer of the present composite material transmits UV light and a UV curing resin is used as the bonding agent, a durable bond between the woven layer and the nonwoven layer can be effected through irradiation with UV light.

Another embodiment of the present invention concerns a special composite material comprising a woven layer and a finish layer, which finish layer has been applied by using a scatter coating process. Suitable finish layers include, for example, EVA (ethyl vinyl acetate), polyethylene, in particular LDPE (low-density polyethylene), HDPE (high-density polyethylene), polyester, polyamide and polyurethane powders, or a combination of two or more thereof. It should be noted in this context that the finish layer bonds to the woven layer in such a manner that the risk of the finish layer coming loose during normal use is reduced to a minimum. It is preferable to select the woven material from yarns of polypropylene, polyethylene, polyacryl, chlorine fibre, aramid, kevlar, elastane, Lyocell (brand), Tencel (brand), jute, hemp, ramie, sisal, silk, carbon fibre, glass fibre, banana fibres, viscose, polyester, polyamide, acetate, cotton, flax and wool, or a mixture of two or more thereof, in which in particular a combination of cotton and polyester is used as the woven material, which woven material exhibits a good resistance against slippage between the yarns when polyester is used for the warp yarns and cotton is used for the weft yarns.

In the combination of a nonwoven material and a woven material in a mattress cover, which materials are permanently bonded together whilst retaining the flexible character of the woven layer, the use of the nonwoven material and the material used for bonding together the woven layer and the nonwoven layer, and also the process conditions being used, provides an increased seam strength and an increased resistance against slippage between the yarns in the woven material, so that the yarns in the woven material are fixed relative to each other. In addition, the original gloss of the woven material is more or less retained as a result of the use of a nonwoven material, whilst in addition to that the final mattress cover is flexible, soft and voluminous to the touch. In addition, the use of a special nonwoven layer enables variations in the transparency and the weight of the final composite material, which the consumer will appreciate in practice.

The present invention furthermore relates to a mattress provided with a mattress cover, viz. the mattress cover as described above or the mattress cover obtained from the present composite material as described above.

The essence of the present invention is especially the forming of a composite material, which composite material is in particular suitable for use as a mattress cover. The special combination of a nonwoven material and a woven material results in a mattress cover which is slightly voluminous to the touch, which effect is imparted by the nonwoven material that is bonded to the woven material, in which the original gloss of the woven material is more or less retained, and which is less transparent than a mattress cover, in particular a mattress cover formed of a polyester-polypropylene fabric having a low shot density, for example 10 shots/cm, that has been manufactured in accordance with the above-discussed prior art from a woven material that has been subjected to an acrylate or polyurethane finishing treatment, using the squeegee technique. In addition to that it has appeared that the present composite material comprising a woven layer and a finish layer, which finish layer has been applied by means of a scatter coating process, is in particular suitable for use as a mattress cover.

### EXAMPLES 1-3 AND COMPARATIVE EXAMPLES 1-3

A woven material formed of polyester warp yarns and cotton weft yarns was permanently bonded to a nonwoven material, in particular polypropylene, by means of a scatter coating process, so that a mattress cover according to the present invention was obtained. Furthermore, a mattress cover was produced in accordance with the so-called wet process, in which a foamy acrylate coating was applied by means of a squeegee system. The materials thus obtained were subjected to the BS 3320 (British Standard 3320) test, in which a sample is folded double and a seam is stitched by using a predetermined number of stitches/cm. Subsequently, a force is exerted at both ends, and the force that needs to be exerted in order to obtain a specific seam opening is measured. The numbers that are shown in the table below represent the force required for obtaining a specific seam opening.

TABLE

| | | | | Warp | | Weft | | Yarn moves out | |
|---|---|---|---|---|---|---|---|---|---|
| | | | | Seam opening | | Seam opening | | fully at | |
| | | | | 3 mm | 6 mm | 3 mm | 6 mm | Warp | Weft |
| Example No | Warp yarn | Weft yarm | Shots/cm | (N) | (N) | (N) | (N) | (N) | (N) |
| 1 | Polyester 167/1 dtex | Cotton Nm 10/1 | 10 | 35 | 100 | 45 | 90 | 195 | 110 |
| Comparative | Polyester 167/1 dtex | Cotton Nm 10/1 | 10 | 40 | 75 | 30 | 50 | 130 | 65 |
| example 1 | | | | | | | | | |
| 2 | Polyester 167/1 dtex | Cotton Nm 14/1 | 15 | 75 | 170 | 60 | 125 | — | 150 |
| 3 | Polyester 167/1 dtex | Polypropylene 300 den | 10 | 55 | 105 | 35 | 50 | 140 | 60 |
| 4 | Polyester 167/1 dtex | Polypropylene 300 den | 14 | 70 | 155 | 60 | 105 | — | 110 |
| Comparative | Polyester 167/1 dtex | Cotton Nm 14/1 | 15 | 30 | 75 | 40 | 80 | 125 | 115 |
| example 2 | | | | | | | | | |
| Comparative | Polyester 167/1 dtex | Polypropylene 300 den | 10 | 30 | 65 | 20 | 25 | 190 | 35 |
| example 3 | | | | | | | | | |
| Comparative | Polyester 167/1 dtex | Polypropylene 300 den | 14 | 25 | 90 | 35 | 55 | 185 | 70 |
| example 4 | | | | | | | | | |

Nm = (number metric) number of kg per km.
dtex = (decitex) number of grammes per 10 km.
den = (denier) number of grammes per 9 km.

From the above measuring data it appears that the force required for obtaining a specific seam opening is significantly higher in the case of the mattress cover according to the present invention than in the case of a mattress cover according to the prior art, i.e. a mattress cover obtained by using the wet process. Thus it is apparent that the method according to the present invention constitutes a distinct improvement over the method according to the prior art.

1. A mattress cover formed of a composite material consisting of a nonwoven material and a woven layer, characterized in that the nonwoven material comprises a single nonwoven layer, in which said nonwoven layer and said woven layer are permanently bonded together whilst retaining the flexible character of the woven layer.

2. A mattress cover according to claim 1, characterized in that the material of the single nonwoven layer has been selected from the group consisting of polypropylene, polyester, polyamide, acetate and viscose, or a mixture of two or more thereof.

3. A mattress cover according to any one or more of the preceding claims, characterized in that the weight of the nonwoven material is maximally 50 g/m².

4. A mattress cover according to claim 3, characterized in that the weight of the nonwoven material is maximally 20 g/m².

5. A mattress cover according to claim 4, characterized in that the weight of the nonwoven material ranges between 12-20 g/m².

6. A mattress cover according to any one or more of the preceding claims, characterized in that polypropylene is used as the nonwoven material.

7. A mattress cover according to claim 6, characterized in that spunbonded polypropylene is used.

8. A mattress cover according to any one or more of the preceding claims, characterized in that the single nonwoven layer comprises two separate sub layers of nonwoven materials.

9. A mattress cover according to any one or more of the preceding claims, characterized in that the woven material has been selected from yarns made from polypropylene, polyethylene, polyacryl, chlorine fibre, aramid, kevlar, elastane, Lyocell (brand), Tencel (brand), jute, bamboo, maize, hemp, ramie, sisal, silk, carbon fibre, glass fibre, banana fibres, bamboo, viscose, polyester, polyamide, acetate, cotton, flax and wool, or a mixture of two or more thereof.

10. A mattress cover according to claim 9, characterized in that a combination of polypropylene and polyester is used as the woven material.

11. A mattress cover according to any one or more of the preceding claims, characterized in that said nonwoven layer and said woven layer are permanently bonded together by means of a bonding agent applied by means of a scatter coating process.

12. A mattress cover according to claim 11, characterized in that the amount of bonding agent is 8-20 g/m².

13. A mattress cover according to any one or more of the preceding claims, characterized in that the warp density of the woven material is 10-90 yarns/cm.

14. A mattress cover according to any one or more of the preceding claims, characterized in that the weft density of the woven material is 4-50 shots/cm.

15. A method of manufacturing a mattress cover as defined in any one or more of the preceding claims, characterized in that the method comprises the following steps:
a) providing a nonwoven material,
b) providing a woven material,
c) applying a bonding agent to the woven material of step b) or to the nonwoven material of step a),
d) combining the nonwoven material from step a) and the woven material from step b) in such a manner that the bonding agent that has been applied in step c) is present between the two materials, and
e) treating the assembly thus obtained in such a manner that the mattress cover is obtained, in which the nonwoven layer from step a) and the woven layer from step b) are permanently bonded together whilst retaining the flexible character of the woven layer.

16. A method according to claim 15, characterized in that the treatment that is used in step e) comprises a calendering treatment.

17. A method according to any one or more of the claims 15-16, characterized in that a powdery bonding agent is applied by means of a scatter coating technique according to step c).

18. A composite material comprising a woven layer and a finish layer, which finish layer has been applied by means of a scatter coating process.

19. A composite material according to claim 18, characterized in that the woven material has been selected from yarns made from polypropylene, polyethylene, polyacryl, chlorine fibre, aramid, kevlar, elastane, Lyocell (brand), Tencel (brand), jute, bamboo, maize, hemp, ramie, sisal, silk, carbon fibre, glass fibre, banana fibres, viscose, polyester, polyamide, acetate, cotton, flax and wool, or a mixture of two or more thereof.

20. A composite material according to claim 19, characterized in that a combination of cotton and polyester is used as the woven material.

21. A mattress provided with a mattress cover as defined in any one or more of the claims 1-14.

22. A mattress provided with a composite material as defined in any one or more of the claims 18-20.
